(19) United States
(12) Patent Application Publication
(10) Pub. No.: US 2006/0262094 A1
(43) Pub. Date: Nov. 23, 2006

(54) Optical mouse having a dual light source and a method thereof

(76) Inventor: Yuan-Jung Chang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/134,403

(22) Filed: May 23, 2005

(51) Int. Cl. G09G 5/08

(52) U.S. Cl. 345/166

(57) ABSTRACT

The present invention resolves the drawback of the sensitivity of sensing of the prior optical mouse and inconvenience in use. To achieve the above purpose, the present. invention provides an optical mouse having a dual light source and a method thereof, by increasing the sensitivity. of sensing and the degree of accuracy on various surfaces, such as rough surface or smooth surface, by using a coherent light source and an incoherent light source and adjusting all angles of the assembly of both. Moreover, the present invention provides an automatic switch mode and a manual switch mode to select a required light source. The automatic switch mode switches on the required light source derived from the track pattern sensed on the surfaces.

### BACKGROUND OF THE INVENTION

1. Field of the Invention

The present invention relates to an optical mouse having a dual light source and a method thereof, and more particularly to an optical mouse that properly operates on a variety of surfaces by using either of dual light sources. Moreover, the optical mouse switches on the light sources by a manual or an automatic means for sensing.

2. Description of Related Art

Reference is made to FIG. 1. The operation rate of a computer host 10 is very fast as a CPU can execute hundreds of millions of operation instructions per second, and is upgraded yearly. Various peripheral devices are necessary to interrelate and communicate between with a user and the computer host 10, such as a monitor 12 to display the information processes of the computer host 10 and a keyboard 11 to enter commands to the computer host 10. Especially when using a Windows operating system (such as Windows 2000 or Linux OS), a mouse 13 is a useful input peripheral device. To improve the efficiency of the mouse 13 in function and technology, the mouse 13 has progressed from a mechanical mouse to an optic-mechanical mouse, or optical mouse.

Reference is made to FIG. 2 and FIG. 1. An optical mouse 20 comprises a cover 21 capable of being opened or closed. It further comprises an integrated circuit unit 23. The integrated circuit unit 23 comprises a sensor 231 and a controller 232. The sensor 231 and the controller 23 are ICs in particular, and they connect to a printed circuit board (PCB) by surface mounting technology (SMT). The optical mouse 20 comprises a wire 24 connects electrically to the integrated circuit unit 23 and the computer host 10, for interrelating and communicating there between.

There is at least one button 22 on the outer surface of the cover 21. The button 22 comprises a button interface 221 connected electrically to the wire 24 inside of the cover 21. A trigger signal is sent to the integrated circuit unit 23 by touching the button 22. The controller 232 of the integrated circuit unit 23 transfers a control signal to the computer host 10, so the executed outcome is displayed on the monitor 12. In addition, the sensor 20 senses a horizontal vector and a vertical vector when a light source 25 of the optical mouse 20 is moved over a certain surface and gets a reflection signal. The track pattern thereof is then transferred to the computer host 10. Hence, the movement and the direction of the optical mouse 20 are displayed on the monitor 12.

In the prior art, the optical mouse 20 has the drawback of movement sensitivity and DPI (dots per inch) because the sensing signal, by which the optical mouse 20 detects the inflection from the surface, is limited by the characteristic of the surface and the wavelength of the light source 25. Therefore, a user must purchase a special reflector cushion and use the optical mouse 25 thereon. If the user abrades or loses the reflector cushion, they must purchase a new one. However, it is inconvenient that some optical mice 20 don't need to use the special reflector cushion but the higher reflectivity of the surface is necessary.

### SUMMARY OF THE INVENTION

The present invention resolves the drawbacks of the sensitivity of sensing of the prior optical mouse and inconvenience of using the same. To achieve the above purpose, the present invention provides an optical mouse having a dual light source and a method thereof. The sensitivity of sensing and the degree of accuracy on various surfaces are improved by using a coherent light source and an incoherent light source. Moreover, the light source, derived from the track pattern that senses on the surfaces, of the present invention can be switched on manually or automatically.

The optical mouse having a dual light source of the present invention comprises a cover, a coherent light source, an incoherent light source arid an integrated circuit unit. The cover can be opened and closed, and comprises at least one button placed on its outer surface. The cover further comprises at least one switch or at least one specific button placed on its outer surface, for switching on the coherent light source, the incoherent light source or an automatic switch mode. The coherent light source and the incoherent light source are placed inside the cover, for providing a beam of light to illuminate the surface and then reflect the beam onto the integrated circuit unit. The integrated circuit unit, placed inside the cover, electrically connects to a computer host, the button, the switch and the specific button. The integrated circuit unit connects to the computer host by wired or wireless technology.

The integrated circuit unit comprises at least one sensing unit, a control unit and an interface unit. The sensing unit detects the reflected beam of the coherent light source or the incoherent light source to form a sensing signal by analyzing the track pattern of the optical mouse as it moves over the surface. The sensing unit is an optical sensor, and the coherent light source and the incoherent light source may be jointly used to illuminate an optical sensor of the same one or respectively used to illuminate an optical sensor of each. The control unit electrically connects to the sensing unit, for interrelating and communicating between the optical mouse and the computer host and controlling a suitable timing to drive the coherent light source or incoherent light source by analyzing the sensing signal, wherein the control unit is a controller. The interface unit electrically connects to the computer host, the button, the coherent light source and the incoherent light source, for communicating the input/output signal of the integrated circuit unit. The integrated circuit unit further comprises a volatile memory or a non-volatile memory, used for storing the sensing signals transferred from the sensing unit and the control signals transferred from the control unit.

A method for operating an optical mouse having dual light source of the present invention when a user selects a automatic switch mode comprises the steps of driving an optical mouse having dual light source from a computer-host; determining whether the optical mouse is switching on an automatic switch mode by triggering at least one switch or a specific button; driving a coherent light source of the optical mouse by the computer host when switching on the automatic mode; and determining whether the optical mouse is detecting a suitable sensing signal. If “yes”, the method keeps driving the coherent light source, otherwise the coherent light source is switched off and the incoherent light source is switched on.

Another method for operating an optical mouse having dual light source of the present invention when a user selects a manual switch mode comprises the steps of driving an optical mouse having dual light source from a computer host; determining whether the optical mouse is switching on an automatic switch mode by triggering at least one switch or a specific button; and determining whether the optical mouse is switching on an incoherent light source of the optical mouse by triggering at least one switch or a specific button when a user isn't switching on an automatic switch mode. If “yes”, the method drives the incoherent light source, otherwise the incoherent light source is switched off and the coherent light source is switched on.

### BRIEF DESCRIPTION OF THE DRAWINGS

The various objectives and advantages of the present invention will be more readily understood from the following detailed description when read in conjunction with the appended drawing, in which:

FIG. 1 is an architecture diagram of the relationship between a computer and a mouse of the prior art;

FIG. 2 is an architecture diagram of the optical mouse of the prior art;

FIG. 3 is an architecture diagram of the optical mouse having dual light source of the present invention;

FIG. 4A is a profile architecture diagram of the optical mouse having dual light source in the first embodiment of the present invention;

FIG. 4B is a profile architecture diagram of the optical mouse having dual light source in an alternate embodiment of the present invention;

FIG. 5 is a flow chart of the method for operating the optical mouse in an automatic switch mode of the present invention; and

FIG. 6 is a flow chart of the method for operating the optical mouse in a manual switch mode of the present invention.

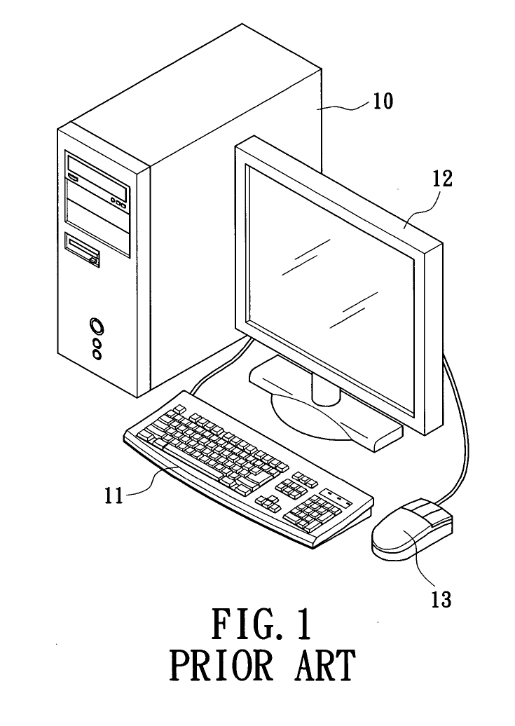

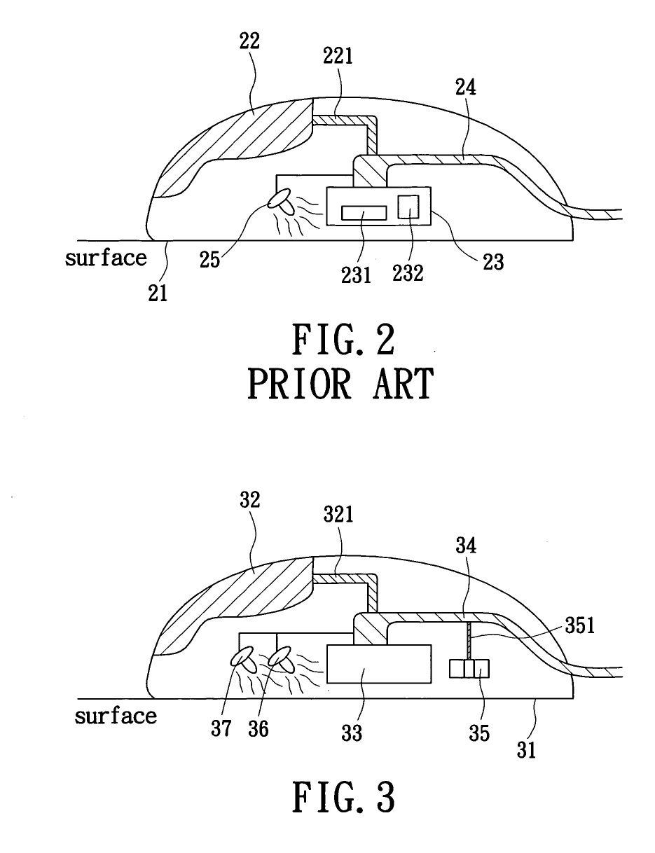

### DETAILED DESCRIPTION OF THE PREFERRED EMBODIMENTS

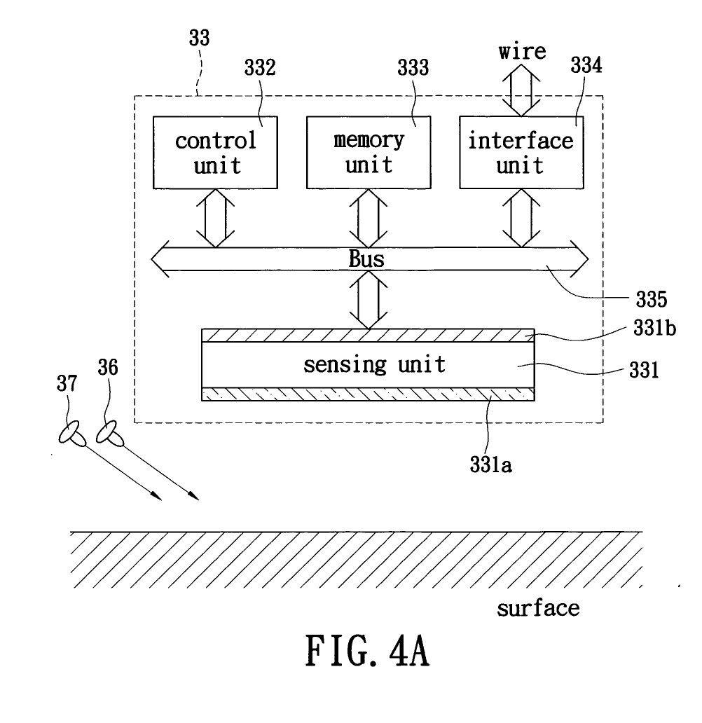

Reference is made to FIG. 3. The optical mouse 30 having dual light source comprises a cover 31, a coherent light source 36, an incoherent light source 37 and an integrated circuit unit 33. The cover 31, which can be opened and closed, comprises at least one button 32 placed on its outer surface for a user enters a request to a computer host 10. The cover 31 further comprises at least one switch or at least one specific button 35 placed on its outer surface, for switching on the coherent light source 33, the incoherent light source 37 or an automatic switch mode. The coherent light source 36 and the incoherent light source 37 are placed inside the cover 31, for providing a beam of light to illuminate the surface and then reflect the beam to the integrated circuit unit 33. The coherent light source 36 is a laser light with a 600-1060 nm wavelength and the incoherent light source 37 is an LED with a visible or invisible light. The integrated circuit unit 33, which can be a PCB board placed inside the cover 31, electrically connects to the button interface 321 of the button 32, the specific button interface 351 of the specific button 35, the coherent light source 36 and incoherent light source 37 by a wire 34. The integrated circuit unit 33 electrically connects to the computer host 10 in a wired or a wireless means; therefore the optical mouse 30 can be a wired/or wireless optical mouse.

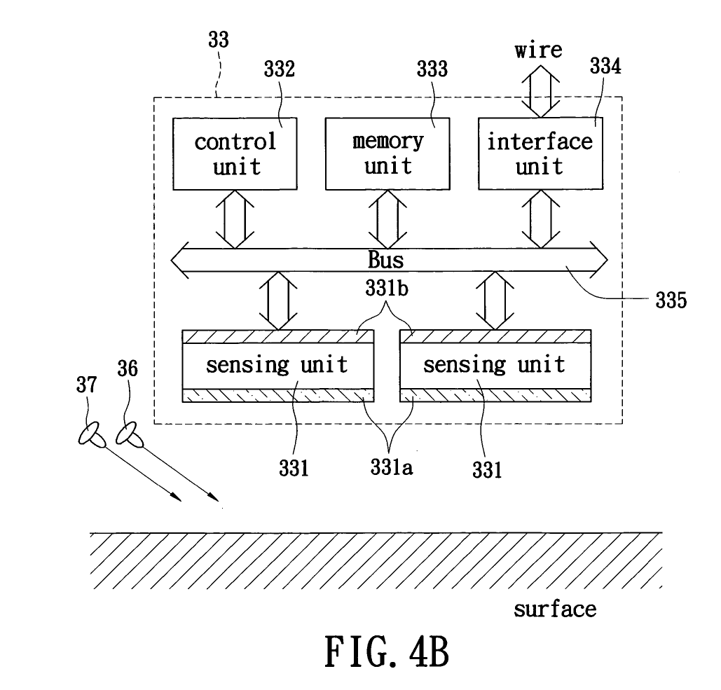

Reference is made to FIG. 4A and FIG. 3. The integrated circuit unit 33 comprises at least one sensing unit 331, a control unit 332 and an interface unit 334. The signal is communicated through a BUS 335. The sensing unit 331, which can be an optical sensor, receives the beam of the coherent light source or the incoherent light source reflected from the surfaces by an optical element 33 la of its, and then transfers that to a photo-sensor element 331b as it moves over the surfaces; the sensing unit 331 is used for analyzing the track pattern of the optical mouse 30 and forming a sensing signal. It should be noted that the coherent light source 36 and the incoherent light source 37 are jointly used to illuminate an optical sensor of the same one.

The control unit 332, electrically connected to the sensing unit 331, can be a controller, for interrelating and communicating between the optical mouse 30 and the computer host 10, and controlling a suitable timing to drive the coherent light source 36 or incoherent light source 37 by analyzing the sensing signal. The interface unit 334 is used for communicating the input/output signal of the integrated circuit unit 33 and it electrically connects to the computer host 10, the button interface 321 of the button 32, the specific button interface 351 of the specific button 35, the coherent light source 36 and the incoherent light source 37. The integrated circuit unit 33 further comprises a memory unit 333, which can be a volatile memory or a non-volatile memory, used for storing the sensing signals transferred from the sensing unit 331 and the control signals transferred from the control unit 332.

Reference is made to FIG. 4B and FIG. 3. It is obviously different in that the coherent light source 36 and the incoherent light source 37 are respectively used to illuminate an optical sensor of each.

In operating the optical mouse 30, the integrated circuit unit 33 needs to analyze the sensing signal, which is derived from the track pattern of the optical mouse 30 as it moves over the surfaces, and then to control a suitable timing for switching on/off the coherent light source 36 or the incoherent light source 37. The optical mouse 30 can obtain the direction and the distances of the movement in high sensitivity and accuracy under switching on a suitable light source. The optical mouse 30 can artificially select a best light source by triggering the specific button or automatically select a best light source by executing the integrated circuit unit 33.

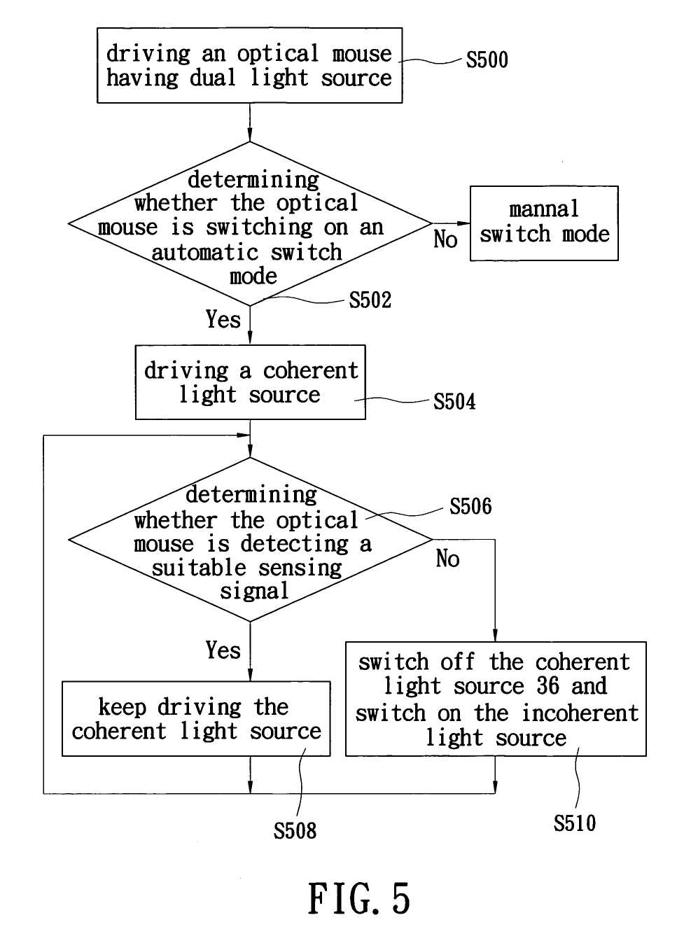

Reference is made to FIG. 5. A method for operating the optical mouse 30 having dual light source of the present invention as a user selects an automatic switch mode comprises the steps of driving an optical mouse 30 having dual light source from the computer host 10 (Step 500); determining whether the optical mouse 30 is switching on an automatic switch mode by triggering a specific button 35 of the optical mouse 30 (Step 502); driving a coherent light source 36 of the optical mouse 30 by the computer host 10 when switching on the automatic mode (Step 504); determining whether the optical mouse 30 is detecting a suitable sensing signal (Step 506); if “yes”, continuing to drive the coherent light source 36 (Step 508); and if not, then switching off the coherent light source 36 and switching on the incoherent light source 37 (Step 510). In the automatic switch mode, the optical mouse 30 keeps on executing the step 506, so as to switch on the required light source.

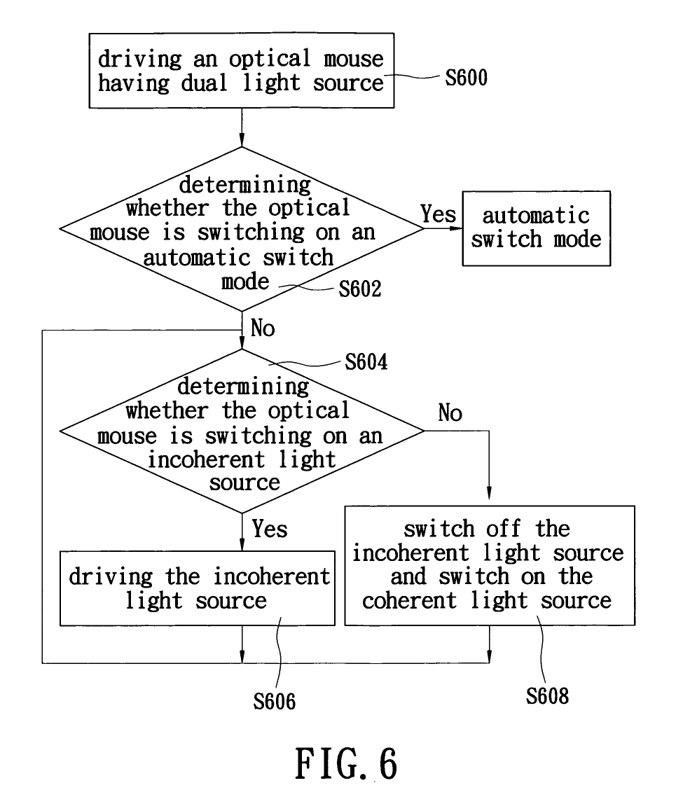

Reference is made to FIG. 6. Another method for operating the optical mouse 30 with dual light source of the present invention as a user selects a manual switch mode comprises the steps of driving an optical mouse 30 having dual light source from the computer host 10 (Step 600); determining whether the optical mouse 30 is switching on an automatic switch mode by triggering a specific button 35 (Step 602); determining whether the optical mouse 30 is switching on an incoherent light source 37 of the optical mouse 30 by triggering the specific button 35 when a user isn't switching on an automatic switch mode (Step 604); if “yes”, driving the incoherent light source 37 (Step 606); and otherwise switching off the incoherent light source 37 and switching on the coherent light source 36 (Step 608). In the manual switch mode, the optical mouse 30 keeps on executing the step 604, so as to switch on the required light source.

An optical mouse has dual light source and a method thereof, and increases the sensitivity of sensing and the degree of accuracy on various surfaces, such as rough surface or smooth surface, by using a coherent light source and an incoherent light source and adjusting all angles of the assembly of both. Moreover, the present invention provides an automatic switch mode and a manual switch mode to select a required light source, in which the automatic switch mode switches on the required light source derived from the track pattern sensed on the surfaces. Finally, for setting up a convenient specification, the coherent light source and the incoherent light source can be jointly used to illuminate an optical sensor of the same one or else respectively used to illuminate an optical sensor of each.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An optical mouse having dual light source, comprising:
a cover, capable of being opened and closed, comprising at least one button placed on an outer surface of said cover;
a coherent light source and an incoherent light source, placed inside said cover, for providing a beam of light to illuminate a surface, the beam then being reflected from the surface; and
an integrated circuit unit, disposed inside said cover and electrically connected to a computer host and said button, comprising:
at least one sensing unit, capable of detecting the reflected beam of said coherent light source or said incoherent light source to form a sensing signal by analyzing a track pattern of said optical mouse during movement over the surface;
a control unit, electrically connected to said sensing unit, for interrelating and communicating between said optical mouse and said computer host and controlling a suitable timing to drive said coherent light source or said incoherent light source by analyzing said sensing signal; and
an interface unit, electrically connected to said computer host, said button, said coherent light source and said incoherent light source, for communicating an input/output signal of said integrated circuit unit;
wherein said optical mouse properly operates on a variety of surfaces by using either of said dual light sources, and said optical mouse automatically controls a suitable timing to switch on/off either of said dual light source by analyzing said sensing signal.

2. The optical mouse as claimed in claim 1, wherein said optical mouse electrically connects to said computer host via wired or wireless technology.

3. The optical mouse as claimed in claim 1, further comprises at least one switch or specific button placed on the outer surface of said cover for switching on/off said coherent light source, incoherent light source, or an automatic switch mode.

4. The optical mouse as claimed in claim 1, wherein said coherent light source is a laser light.

5. The optical mouse as claimed in claim 4, wherein a wavelength range of said laser light is about b 600-1060 nm.

6. The optical mouse as claimed in claim 1, wherein said incoherent light source is an LED with visible or invisible light.

7. The optical mouse as claimed in claim 1, wherein said control unit is a controller.

8. The optical mouse as claimed in claim 1, wherein said sensing unit is an optical sensor.

9. The optical mouse as claimed in claim 1, wherein said coherent light source and said incoherent light source are jointly used to illuminate a sensing unit thereof.

10. The optical mouse as claimed in claim 1, wherein said coherent light source and said incoherent light source are respectively used to illuminate a sensing unit thereof, respectively.

11. The optical mouse as claimed in claim 1, wherein said integrated circuit unit further comprises a volatile memory or a non-volatile memory.

12. A method for operating an optical mouse having dual light source, comprising the steps of:
(a) driving an optical mouse having dual light source from a computer;
(b) determining whether said optical mouse with dual light source switches on an automatic switch mode by triggering at least one switch or specific button;
(c) driving a coherent light source of said optical mouse;
(d) determining whether said optical mouse is detecting a suitable sensing signal; and
(e) driving persistently said coherent light source.

13. The method for operating the optical mouse as claimed in claim 12, wherein if an answer is “yes” in step (d), subsequent steps are executed, and if the answer is “no”, said method executes the following step:
(f) switching off said coherent light source and switching on a incoherent light source.

14. The method for operating the optical mouse as claimed in claim 12 or 13, wherein the method returns to step (d) after step (e) or (f) ends.

15. The method for operating the optical mouse as claimed in claim 12, wherein is an answer is “yes” in step (b), subsequent steps are executed, and if the answer is “no”, said method executes the following steps:
(g) determining whether said optical mouse is switching on an incoherent light sources; and
(h) driving said incoherent light source.

16. The method for operating the optical mouse as claimed in claim 15, wherein if an answer is “yes” in step (d), subsequent steps are executed, and if the answer is no, said method executes the following step:
(i) switching off said incoherent light source and switching on said coherent light source.

17. The method for operating the optical mouse as claimed in claim 15 or 16, wherein the method returns to step (g) after step (h) or (i) ends.

18. The method for operating the optical mouse as claimed in claim 12, wherein said optical mouse comprises:
a cover, capable of being opened and closed, comprising at least one button placed on an outer surface of said cover;
a coherent light source and an incoherent light source, placed inside said cover, for providing a beam of light to illuminate a surface and then reflecting the beam from the surface; and
an integrated circuit unit, disposed inside said cover and electrically connected to a computer host and said button, comprising:
at least one sensing unit, capable of detecting the reflected beam of said coherent light source or said incoherent light source to form a sensing signal by analyzing a track pattern of said optical mouse during movement over the surface;
a control unit, electrically connected to said sensing unit, for interrelating and communicating between said optical mouse and said computer host and controlling a suitable timing to drive said coherent light source or said incoherent light source by analyzing said sensing signal; and
an interface unit, electrically connected to said computer host, said button, said coherent light source and said incoherent light source, for communicating an input/output signal of said integrated circuit unit.

19. The method for operating the optical mouse as claimed in claim 18, wherein said optical mouse electrically connects to said computer host via wired or wireless technology.

20. The method for operating the optical mouse as claimed in claim 18, wherein said coherent light source is a laser light.

21. The method for operating the optical mouse as claimed in claim 20, wherein a wavelength range of said laser light is about 600-1060 nm.

22. The method for operating the optical mouse as claimed in claim 18, wherein is said incoherent light source is an LED with a visible or invisible light.

23. The method for operating the optical mouse as claimed in claim 18, wherein said control unit is a controller.

24. The method for operating the optical mouse as claimed in claim 18, wherein said sensing unit is an optical sensor.

25. The method for operating the optical mouse as claimed in claim 18, wherein said coherent light source and said incoherent light source are jointly used to illuminate a sensing unit thereof.

26. The method for operating the optical mouse as claimed in claim 18, wherein said coherent light source and said incoherent light source are respectively used to illuminate a sensing unit thereof, respectively.

27. The method for operating the optical mouse as claimed in claim 18; wherein said integrated circuit unit further comprises a volatile memory or a non-volatile memory.
